(19) United States
(12) Patent Application Publication
(10) Pub. No.: US 2007/0117081 A1
(43) Pub. Date: May 24, 2007

(54) System and Method for Delivering Information to Optimize Information Retention

(76) Inventor: John Hajime Ford, San Francisco, CA (US)

Correspondence Address: WILSON SONSINI GOODRICH & ROSATI, 650 PAGE MILL ROAD, PALO ALTO, CA, 94304-1050, US

(21) Appl. No.: 11/551,417

(22) Filed: Oct. 20, 2006

Related U.S. Application Data
(60) Provisional application No. 60/745,424, filed on Apr. 24, 2006.
(60) Provisional application No. 60/743,584, filed on Mar. 20, 2006.
(60) Provisional application No. 60/741,830, filed on Dec. 1, 2005.
(60) Provisional application No. 60/731,225, filed on Oct. 31, 2005.

(51) Int. Cl. G09B 3/00

(52) U.S. Cl. 434/350

(57) ABSTRACT

The invention teaches a system for use at a location, such as a health club, home or school. The system manages all or some of course scheduling, course delivery, instructor scheduling, participant information, course information, registration, and fee payment. Analysis of course selections to demographics and/or survey information can also be provided by the system. The system also provides a mechanism for providing target variable parameter information for participants in either a generic value or a participant specific value.

### RELATED APPLICATION

This Provisional Patent Application claims the benefit of: U.S. Provisional Patent Application 60/745,424 filed Apr. 24, 2006 entitled System and Method for Delivering Information to Optimize Information Retention (Ford), U.S. Provisional Patent Application 60/743,584 filed Mar. 20, 2006 entitled System and Method for Delivering Information to Optimize Information Retention (Ford), U.S. Provisional Patent Application 60/741,830 filed Dec. 1, 2005, entitled System and Method for Delivering Information to Optimize Information Retention (Ford); and Provisional Patent Application 60/731,225 filed Oct. 31, 2005, entitled System and Method for Delivering Information (Ford).

### BACKGROUND OF THE INVENTION

The results from the 1999-2002 National Health and Nutrition Examination Survey (NHANES), using measured heights and weights, indicate that an estimated 65 percent of U.S. adults are either overweight or obese. The breakdown indicates that an estimated 30% are obese (which is defined as a Body Mass Index of 30 or higher), while 35% are overweight. Body Mass Index (“BMI”) is calculated by dividing a person's body weight in kilograms by their height in meters squared. In addition to these statistics for adults, an estimated 15.5 percent of adolescents (ages 12 to 19) and 15.3 percent of children (ages 6 to 11) are estimated to be obese in the United States.

Although it seems counterintuitive, perhaps as a result of these alarming statistics, the United States is currently experiencing a boom in the health club industry. The number of health clubs in the US has climbed to 26,830 from just 15,372 in the year 2000—a 75% increase. An estimated 41 million Americans belong to health clubs and that number is expected to increase to over 50 million by the year 2010. The 2004 US health club industry comprised a 14.8 billion dollar market, more than double the 7.3 billion dollar market seen just one decade prior. These market changes can be correlated to the American obesity crisis, an appearance focused culture, and the increasing health awareness of the population, and are not expected to slow or stop in the foreseeable future.

As reported by the Centers for Disease Control and Prevention (www.cdc.gov), physical activity can bring many health benefits. In fact, it has been found that people who enjoy participating in moderate intensity or vigorous intensity physical activity on a regular basis lower their risk of developing coronary heart disease, stroke, non-insulin dependent (type 2) diabetes mellitus, high blood pressure, and colon cancer by 30-60% (US DHHS, 1996). Additionally, active people have lower premature death rates than people who are the least active. Even among frail and older people, mobility can be improved through physical activity. Butler, R N, et al., “Physical Fitness: Benefits of Exercising for the Older Patient” Geriatrics 53(10): 46-52 (1998). Researchers have even found a correlation between walking and a lower incidence of Alzheimers.

Another notable trend has been the increasing market for continuing education, which has experienced impressive growth in recent years. As America's blue collar jobs continue to be shipped overseas in increasing numbers, America's work force is quickly becoming more educated, and the demand for continuing education to improve or maintain skills in an increasingly educated work force is increasing in response to this changing labor market. The most recent 2001 report on the topic by the National Center for Educational Statistics indicated that 46% of the American adult population were continuing education participants, up from 40% in 1995. Additionally, studies have shown that people who are mentally active throughout their lives are significantly less likely to suffer senility. A handful of studies have also shown that mental activity boosts brain function.

An additional trend has been the development of dozens of completely new types of group fitness that emerge each year. These fitness classes are typically designed to combine two popular forms of fitness or activities into one class. For example, YogaSpin, a combination of Yoga and group stationary cycling, Extreme Boot Camp, Cheerleading School, Cycling Karaoke, and countless variations based on the popular Cardio Kickboxing and Pilates exercise platforms.

Over the last decade neuroscientists have performed a number of studies that have provided data indicating that the brain changes after physical activity. Further, there has been a suggestion that movement enhances memory, learning, attention, decision making and multitasking. A correlation between physical activity and increases in brain chemicals (neurotransmitters) is thought to play a role in cognition.

There are also a variety of studies analyzing the relationship between physical exercise and mental performance. Typically, these studies are conducted in an effort to assess decision making for athletes during athletic performance. For example, McGlynn, et al., administered a line-matching test to 15 female students exercising on a motor-driven treadmill. They concluded that “increased levels of concomitant exercise had no significant effect on accuracy of performance and did not produce increased speed of mental performance, except in the last stage of exercise which differed significantly from the first three stages.” McGlynn, G H, et al. “The Effects of Increasing Levels of Exercise on Mental Performance,” Ergonomics 22(4): 407-414 (1979). In a study by Paas, et al., it was concluded that “increments in physical workload improved performance on the decision task, but impaired performance on the perception task, whereas decrements in physical workload reduced performance on the decision task and improved performance on the perception task.” Paas F G, et al., “Human Information Processing During Physical Exercise,” Ergonomics 34(11): 1385-1397 (1991). In yet another experiment, Fleury, et al., concluded that “performance in the cognitive task is significantly disturbed by the maximal aerobic exercise.” They hypothecated that “cognitive behaviour is handicapped by highly demanding activities, that is, activities requiring aerobic maximal efforts.” Fleury, M, et al. “Effects of Different Types of Physical Activity on the Performance of Perceptual Tasks in Peripheral and Central Vision and Coincident Timing” Ergonomics 30(6): 945-958 (1987). In a review of studies that assessed the effects of acute bouts of physical activity, Tomporowski concluded that submaximal aeorobic exercise performed for periods of up to 60 minutes facilated specific aspects of information processing (Toporowski “Effects of Accute Bouts of Exercise on Cognition,” Acta Psychologica 112 (2003): 297-324.

### SUMMARY OF THE INVENTION

From these studies and statistics, it can be seen that a solution is needed to provide our increasingly busy society with systems and solutions for maximizing time utilization while attending to important needs. Thus, a system and method is needed that enables people to schedule work, family, continuing education and professional development, and much needed exercise into an increasingly busy and demanding schedule. A system is also needed to optimize information retention in individuals. This invention provides systems and methods for addressing this problem.

One aspect of the invention provides an organization, such as a health club, with the ability to receive additional revenues with zero additional effort and cost. A system is provided to manage course scheduling, instructor scheduling, participant information, course information, registration, and fee payment. Analysis of course selections to demographics and/or survey information can also be provided by the system. The system also provides a mechanism for providing target variable parameter information for participants in either a generic value or a participant specific value.

Another aspect of the invention provides targeted workshops combining fitness and information delivery or delivery of educational services. For example, one day, one hour workshops on a specific topic. These courses will cover specific topics that can be addressed in a short time frame and do not require repeat attendance. This will allow members to select topics that interest them and attend those sessions with no other time commitments necessary. An example of this type is an overview course on the latest trends in the stock market and how investors and companies have been interpreting them. These courses can be taught using, for example, one or more live instructors. The courses can also be taught in combination with an information delivery platform. Thus, for example, a kinesiologist or personal trainer can deliver biomechanical or fitness feedback to a participant in combination with a subject provider who engages the participant in the substantive subject of the class. The materials can be configured to provide notes and materials for the subject matter instructor that are correlated to an intensity plan for the fitness instructor to follow concurrently. These correlated materials can be coded, color-coded, etc., to provide suitable prompts.

Another aspect of the invention provides compact, modularized courses combining fitness and information delivery. For example, courses lasting less than 2 weeks. These courses can be structured to occur, for example, 2 to 3 times per week for 1 to 2 weeks, for a total of 2 to 6 sessions. Each individual session can be structured as a stand-alone session such that absence from one session does not reduce the value of later sessions, or such that each session builds upon the next. An example of a topic suitable for this format would be a course on Bordeaux wine varietals. Several sessions spanning a 2 week period would address the characteristics and history of each of the primary Bordeaux varietals.

Yet another aspect of the invention provides longer more structured courses combining fitness and information delivery. For example, a course directed to acquiring a real estate license, may necessarily be longer and more structured in order to meet enforced exam eligibility requirements, or to cover more in-depth and detailed topics. These courses would be scheduled in the most convenient manner possible, and this format will only be used when necessary to provide value to the participant.

Still another aspect of the invention provides ongoing series courses combining fitness and information delivery. These series courses can be taught one to two times per week indefinitely. An example of this type of course would be “The Unofficial Tour de France”, an ongoing weekly French language immersion course that includes culture and geography in an integrated learning/workout experience that leads the students on a simulated cycle through French cities and countryside.

Yet another aspect of the invention provides a tool for information delivery and retention to participants who have a need to achieve dual objectives and/or participants whose information retention would be enhanced as a result of engaging in exercise while being presented with information.

Yet another aspect of the invention provides a system and method for organizing fitness with information delivery in courses wherein the delivery is modularized into learn zones, burn zones and interaction or social zones.

### BACKGROUND

Systems and methods for producing products and services related to the integration of exercise and learning are disclosed. Participants engage simultaneously in physical exercise and non-motor (such as academic) learning. The services can be delivered, for example, by the sue of a touch screen display panel and CPU, which is intended to be attached to cardiovascular fitness equipment, at home or in a fitness facility. Through this display panel, participants are exposed to educational content, typically in the context of a virtual educational bicycling tour through an area which is in some way related to the educational subject matter.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is an overview of a system having a server, a CPU, a monitor, storage media, input devices, etc. which can be used by a user;

FIGS. 2A-B are overviews of a multi-device system and communication network suitable for use with the methods of the invention, including remote systems;

FIGS. 3A-B are flow charts illustrating method steps of an embodiment the invention;

FIGS. 4A-C are flow charts illustrating another set of method steps for additional embodiments the invention that include assessing the difficulty of the information to be delivered, obtaining participant fixed parameters, and selecting an exercise program;

FIGS. 5A-C are flow charts illustrating yet another set of methods steps for additional embodiments of the invention that include monitoring a participant parameter, adjusting a participant parameter, and adjusting exercise intensity; and

FIG. 6 illustrates a flow chart of method steps combining steps shown in FIGS. 3-5.

### DETAILED DESCRIPTION OF THE INVENTION

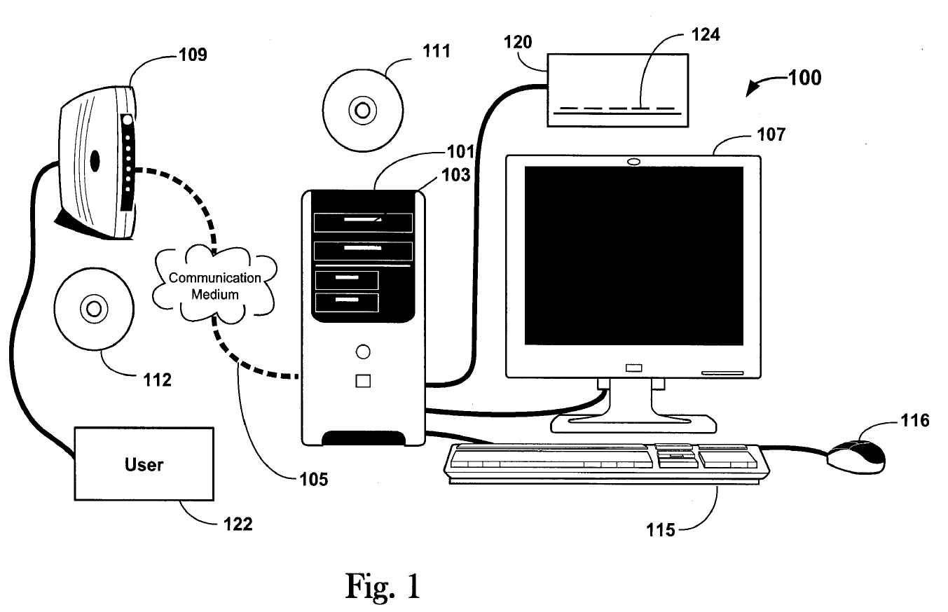

FIG. 1 is a block diagram showing a representative example logic device through which reviewing or analyzing data relating to the present invention can be achieved. Such data can be in relation to exercise, physiological parameter, exertion, learning, retention of information, or any other suitable parameter desired to be measured of a subject. A computer system (or digital device) 100 that may be understood as a logical apparatus that can read instructions from media 111 and/or network port 105, which can optionally be connected to server 109 having fixed media 112. The computer system 100 can also be connected to the Internet or an intranet. The system includes CPU 101, disk drives 103, optional input devices, illustrated as keyboard 115 and/or mouse 116 and optional monitor 107. Data communication can be achieved through the indicated communication medium to a server 109 at a local or a remote location. The communication medium can include any means of transmitting and/or receiving data. For example, the communication medium can be a network connection, a wireless connection or an internet connection. It is envisioned that data relating to the present invention can be transmitted over such networks or connections. The computer system can be adapted to communicate with an participant parameter monitor and/or an apparatus on which a participant is engaged in exercise.

A user or participant 122 can also be connected to a variety of monitoring devices, as described below. The monitoring devices can be used to interact with the system. As will be appreciated by those skilled in the art, the computer system, or digital device, 100 can be any suitable device. Other suitable devices include, for example, video ipod (Apple Corp., Cupertino Calif.), or a portable DVD player or DVD Walkman(r) (Sony Corporation). Such devices would be suitable in a variety of situations. For example, where the participant downloads courses from the internet; where participant interaction is optional; etc. Alternatively, such portable devices could be adapted to communicate with devices measuring participant parameters and/or participant input devices.

In an embodiment, a computer-readable medium includes a medium suitable for transmission of a target information of interest, such as that information discussed in more detail below. The medium can include a result regarding a disease condition or state of a subject, wherein such a result is derived using the methods described herein.

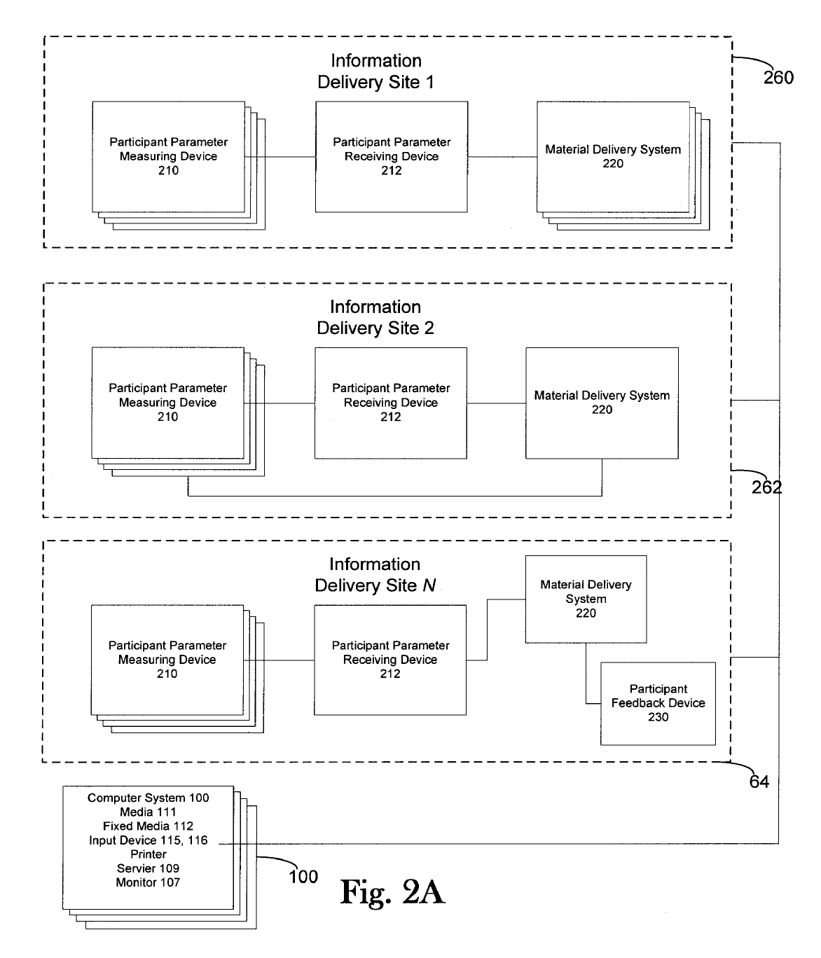

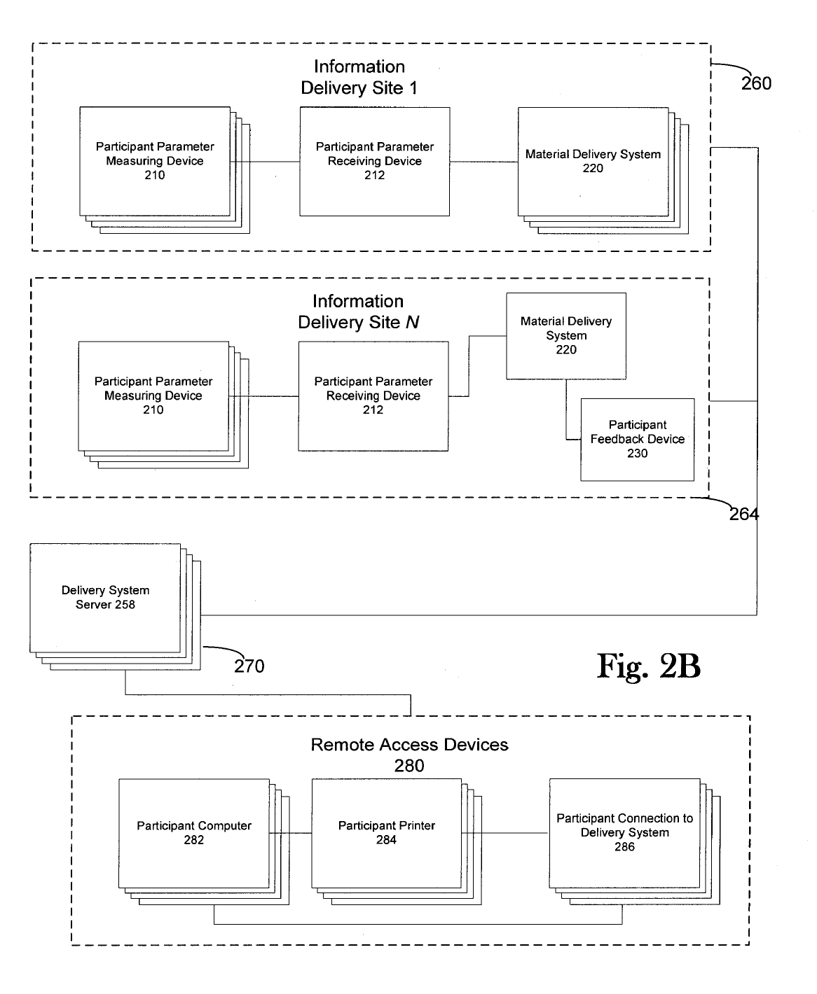

Turning to FIG. 2A, a system overview is provided of a system suitable for use in practicing the methods of the invention. As will be appreciated by those skilled in the art, the system overview is provided as an example and does not exhaust all possible configurations of a suitable system. The system can employ components, such as those described above with respect to FIG. 1.

As evidenced from the system, a plurality of information delivery sites are provided (Information Delivery Site 1 through Information Delivery Site N). Each information delivery site can have one or more participant parameter measuring devices 210 that are capable of measuring a participant parameter. Suitable devices include, for example, heart rate monitors as will be discussed in more detail below. The participant parameter measuring device 200 can communicate directly with a participant parameter receiving device 212 as illustrated in Information Delivery Site 1 260, or it can be configured to communicate directly with material delivery system 220 as shown in Information Delivery Site 2 262. The material delivery system can be one or more computers that contain information about the participants, the ability to process information about the participant, and the ability to deliver the material to be delivered in the class, as discussed below. More than one material delivery system 220 is suitable where, for example, each participant has their own material delivery interface. Thus, for example, each participant could be provided with a screen that delivers material directly to that participant. The material delivery system 220 is provided intensity input to a participant, for example, based on the type of information delivered.

In yet another configuration, one or more of the Information Delivery Sites 260, 262, 264 can be connected to a participant feedback device 260 as shown in Information Delivery Site N. The participant feedback device 260 can include one or more devices as desired. Participant feedback devices include, for example, a heart rate monitor wrist watch that reports the heart rate detected from a participant. Additionally, the central computer 270 can be configured to deliver the material to the Information Deliver Site which can be a remote location. Such delivery can be, for example, by Internet or intranet access. Communication between devices can be wired or wireless. Additionally, one or more participant feedback devices 230 can be provided that enable the user to, for example, answer tests during administration of the course to assess information retention.

One or more of the Information Delivery Sites 260, 262, 264 can be connected by any suitable method, such as the Internet or wireless device, to a central system 270. The central system 270 can include one or more computers 250, terminals 252, consoles 254 and/or printers 256 or servers 258 as desired. Additionally, the central computer 270 can be configured to deliver the material to the Information Deliver Site which can be a remote location. Such delivery can be, for example, by Internet or intranet access. Communication between devices can be wired or wireless. Additionally, one or more participant feedback devices 230 can be provided that enable the user to, for example, answer tests during administration of the course to assess information retention. For example, an on screen question/answer session can occur through feedback device to ensure that learning or participation is occurring.

Turning now to FIG. 2B, a system is depicted where one or more participant computers 282 access a server 258 As will be appreciated by those skilled in the art, the various computers and devices can be in close proximity (e.g., within the same room) or at distant locations, without departing from the scope of the invention. Thus, the participant can access the server 258 through any suitable process, including accessing via the Internet or intranet, or by using a wireless device.

Parameter measurement devices include, for example, devices capable of measuring a biologic function, such as heart rate, blood pressure, blood sugar or glucose levels, body temperature, tissue oxygenation, volume of O₂ (VO2), pulse oximeter measurement (Sp O₂), electroencephalogram measurement (EEG), O₂ saturation, or any other measurement that can be obtained from the participant. See, for example, U.S. Patent Publications US 2005/0166373 entitled Case Structure for Sensor Structure Attachable to and Detachable From a Shoe (Saasko et al.), US 2005/0135039 entitled Electric Circuit and Transmission Method for Telemetric Transmission (Klemetti), US 2005/0130802 entitled Arrangement, Method and Computer Program for Determining Physical Activity Level of Human Beings (Kinnunen), US 2005/0111307 entitled Electronic Wrist Device (Saaski et al.), US 2005/0111306 entitled Portable Wrist-Worn Personal Electronic Device (Saaski et al.), US 2005/0017850 entitled Mechanical Measuring Device and a Measuring Method (Nissala), US 2005/0004436 entitled Method and Device for Weight Management of Humans (Nissala), US 2004/0220738 entitled Portable Personal Data Processing Device (Nissala), and US 2004/0220485 entitled Method and Device for Measuring Heart Rate, and for Manufacturing the Device (Rytky). U.S. Pat. No. 6,832,109 entitled Wrist-Worn Device for Displaying and Setting Heart Rate Parameters (Nissala); U.S. Pat. No. 6,754,517 entitled Apparatus for Measuring Electrocardiograph Signal (Nissila); U.S. Pat. No. 6,714,812 entitled Method of Performing Operating Settings in Heart Rate Measurement Arrangement, and Heart Rate Measurement Arrangement (Karjalainen); U.S. Pat. No. 6,687,535 entitled Controlling of Fitness Exercise (Hautala et al.); U.S. Pat. No. 6,605,044 entitled Caloric Exercise Monitor (Bimbaum); U.S. Pat. No. 6,584,344 entitled Method and Apparatus for Measuring Heart Rate (Hannula); U.S. Pat. No. 6,554,773 entitled Method and Arrangement for Blood Pressure Measurement (Nissila); U.S. Pat. No. 6,553,247 entitled Electrode Belt of Heart Rate Monitor (Rytky); U.S. Pat. No. 6,540,686 entitled Measurement Relating to Human Body (Heikkila et al.); U.S. Pat. No. 6,443,904 entitled Determination of Stress Level of Fitness Exercise (Nissila); U.S. Pat. No. 6,954,661 entitled Blood Sugar Measuring Apparatus (Cho et al.); U.S. Pat. No. 6,746,415 entitled Method of Blood Constituent Monitoring Using Improved Disposable Eletrocorporeal Conduit (Steuer et al.); U.S. Pat. No. 5,251,632 entitled Tissue Oxygen Measuring System (Delpy); U.S. Pat. No. 4,368,740 entitled Physiologic Analyzer (Binder); U.S. Pat. No. 6,912,413 entitled Pulse Oximeter (Rantala et al.); U.S. Pat. No. 6,879,850 entitled Pulse Oximeter with Motion Detector (Kimball); U.S. Pat. No. 6,829,496 entitled Blood Component Measurement Apparatus (Nagai et al.); U.S. Pat. No. 6,950,697 entitled Electroencephalagram Acquisition Method and System (Jordan); U.S. Pat. No. 6,829,502 entitled Brain Response Monitoring Apparatus and Method (Hong et al.); U.S. Pat. No. 6,510,340 entitled Method and Apparatus for Encephalography (Jordan); U.S. Pat. No. 6,909,912 entitled Non-Invasive Perfusion Monitor and System, Specially Configured Oximeter Probes, Methods of Using Same, and Covers for Probes (Melker); and U.S. Pat. No. 6,850,789 entitled Combination SPO2/temperature Measuring Apparatus (Scheitzer Jr., et al.). Parameter measurement devices also include, for example, a participant monitoring their pulse manually by placing a finger, for example, on the carotid artery or near the wrist to determine the number of beats per minute. See also, U.S. Pat. No. 5,170,780 to Rosenfeld for Method of Credibility Assessment Based on Feedback-Elicited P3 Responses of Brain and European Patent Publication EP 1510175 A1 to Kostucki for Exercise Manager Program.

In another example of a deployment system for the methods of the invention, a data processing system for administering course material is provided comprising a computer or server. The computer can, if desired, be connected to a network of remote stations. In operation, the remote stations could then serve as the data entry points for information to be gathered, for example at a remote class site or by a participant registering for a class on-line. Information gathered includes, for example, information about the materials to be presented, the participant, the environment, etc. The remote stations can also serve as access points through which people transmit inquiries concerning the materials presented or exercise programs and for responding to those inquiries. Additionally, each station can store a record of each participant's details, including performance information for each class, and periodically send this information to the central computer for processing.

The computer can be adapted and configured to receive and process participant data from the remote stations, respond to inquiries, and initiate reporting. The data processing system operating on the computer or server can then update the list of participant accounts, including opening new accounts and participant records and closing accounts and records for participants who are not actively enrolled. This system can also provide confirmation of course and performance status to the relevant station when, for example, a participant completes a course, or participant parameters result in a change of the collected participant parameter. The computer or server can also be configured to furnish information to the course instructor concerning new participants, parameter changes, course content changes, etc.

Additionally, the computer, server or remote station can be configured to receive information from a parameter measurement device associated with a participant. Such information can be provided before, during and/or after participation in the course material. The parameter measurement device can be configured to receive participant parameters directly and may function in some or all aspects as the remote station. Communication between the remote station and the computer or server can be achieved using a variety of suitable connectors, either wired or wireless.

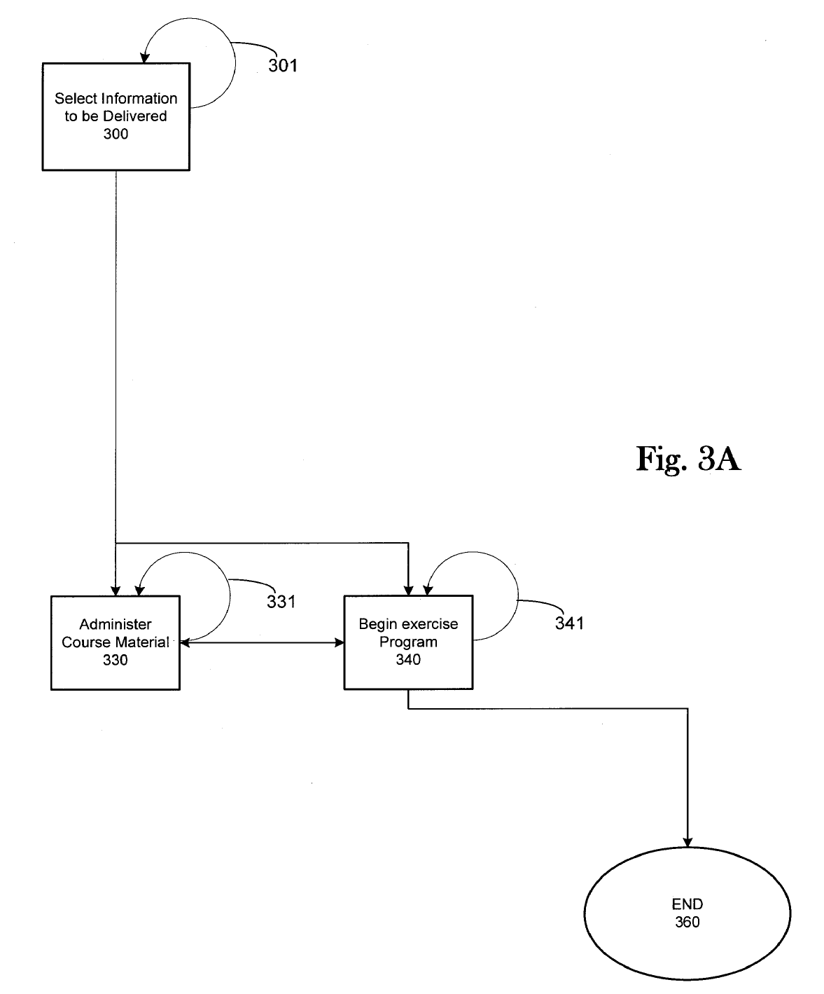

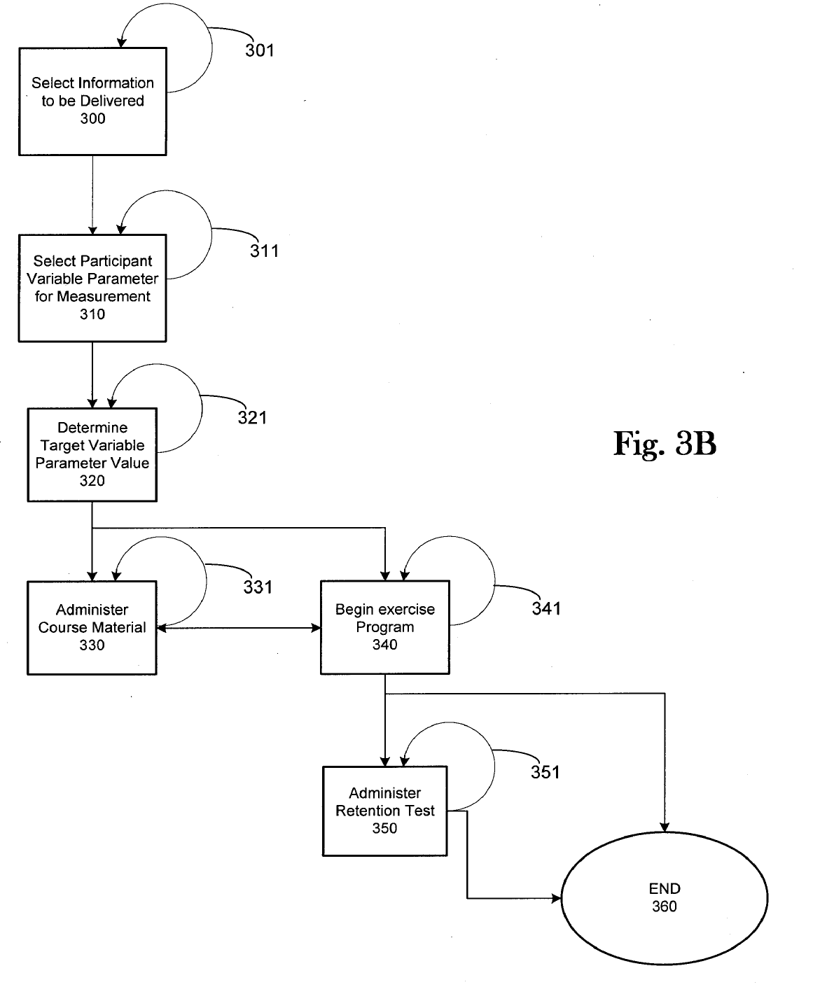

With the foregoing overview in mind, the operation of the system can best be understood by first referring to FIGS. 3A-B, which provides an overview of the operation of the system in the context of delivering course materials in conjunction with engaging in an exercise program. As will be appreciated by those skilled in the art, the various methods can be performed partially or completely on a computer or other system capable of receiving and delivering information to a participant. Similarly, the various methods can be performed partially or completely manually by one or more persons, including participants and trainers.

Initially, the information to be delivered is selected 300. The information to be delivered 300 can include material of any type which is presented in a variety of manners including, but not limited to: live instructor presentation by one or more instructors, PowerPoint presentation, overhead projection, video presentation, audio presentation, web feed, etc. The topics of material covered for presentation can be selected from a wide variety of educational and general interest materials. For example, language courses, history courses, general interest courses, self-improvement courses, continuing professional education courses, professional licensing courses, and the like. Additionally, for example, a video presentation could be focused on material with a picture in picture component that indicates technique for exercise, changes in intensity, changes in type of exercise, etc. In some instances, it may be desirable to have the exercise component of the information delivery, or class, taught and/or monitored by a kinesiologist, exercise physiologist and/or personal trainer (such as those persons certified as personal trainers by the American Council on Exercise). The information/educational component can then be taught and/or monitored by an instructor knowledgeable in the subject matter. In other instances, it may be desirable to have the exercise component of the information delivery monitored by a live instructor, while the substantive/educational component is interactive through, for example, an interactive web system. The information or materials delivered can also be coded to prompt instructors to, for example, increase intensity in combination with delivery of the coded material.

So, for example, in a Spinning® class, where the participants are taken through a workout that includes five core movements, a certified Spinning® instructor may oversee the Spinning portion of the class, including instructing the participants on when to engage in one of the five core movements at any given time, and correcting form to reduce injury. A second instructor, system, or interactive system, may then coach the participants in Spanish and encourage class dialog at designated times. In still other situations, the two instructors may be one, where a person knowledgeable in Spanish is also certified to teach Spinning®. As will be appreciated, a variety of methods can be employed which are within the scope of the invention.

As indicated by repeat arrow 301, the step of selecting information to be delivered 300 can be repeated as frequently as desired. Selection of information to be delivered can be accomplished at two or more times. For example, a participant or their representative (e.g. a parent registering a minor) can register for a class by selecting material to be delivered, among other variables, to select a class to register for. Where the material to be presented is delivered by, for example, a web-feed, a participant could select the material in conjunction with preparing to engage in exercise. Alternatively, where a live class is conducted, the instructor can select the material to be delivered from, for example, a menu on a computer, or by opening an electronic file located on a computer that contains the companion materials to the live instruction. Thereafter, in the course material is administered 330 and the participant begins the exercise program 340. Any of these steps can be repeated, if desired, before, ending 360.

As illustrated in FIG. 3B, at least one participant variable parameter can also be obtained for measurement 310. Participant variable parameters include, for example, data pertaining to a biologic function such as heart rate, volume of O2 (VO2), pulse oximeter measurement (SpO2), electroencephalogram measurement (EEG), O2 saturation, or any other measurement that can be obtained from the participant, including perceived exertion levels. Additionally, or alternatively, more than one participant variable parameter can be selected 311 for measurement, if desired.

The system can analyze a variety of the information obtained to determine a target variable parameter value 320. This process can be repeated as often as desired 321. As will be appreciated, any combination of the above information can be used to generate the target variable parameter for a participant specific parameter or a general parameter, can be provided based on a subset of the information collected on a participant.

Once the target variable parameter is obtained 320, either sequentially or simultaneously, an instructor can administer course material 330 and the participant can begin the exercise program 340. As discussed above, the “instructor” can be a live instructor, a simulated instructor or a plurality of instructors. As will be appreciated by those skilled in the art, the step of administering course material can be repeated 331, and the step of beginning the exercise program can be repeated 341. For example, a series of course materials could be delivered in a single session comprising multiple blocks of materials. Additionally, breaks in the exercise program can be provided, if desired where the total length of time of the course administration exceeds, for example, one hour. As evidenced by the process lines and arrows, the steps of administering course material 330 and beginning the exercise program 340 can occur in any order, including sequentially or simultaneously. As will be appreciated, any of steps 300-320 can be performed remote in time to the administration of the courses and engaging in the exercise program without departing from the scope of the invention. Thus, for example, a participant could fill out a questionnaire during course registration using a web-enabled interface. The information would then be stored in the network or on the server and when the participant engaged in the class, then the information would be used for purposes of determining, for example, desired participant parameter.

Additionally, as will be appreciated by those skilled in the art, exercise programs can be any suitable program which may or may not include the use of one or more machines, or a machine in combination with a manual component. Suitable devices include, for example, treadmills, elliptical trainers, stationary cycles, rowing machines, Spinning® cycles, to name a few. It is within the scope of the invention to vary the participant's exercise within an exercise regime, particularly where space and access to equipment is not a factor. Thus, a portion of the material could be presented while the participant was on a treadmill, and then another portion presented while the participant was on a stationary cycle or Spinning® cycle. Additionally, weights could be provided for resistance training.

As illustrated in FIG. 3B a retention test can optionally be administered 350 prior to ending the session 360. Additionally, retention testing can be repeated 351, if desired.

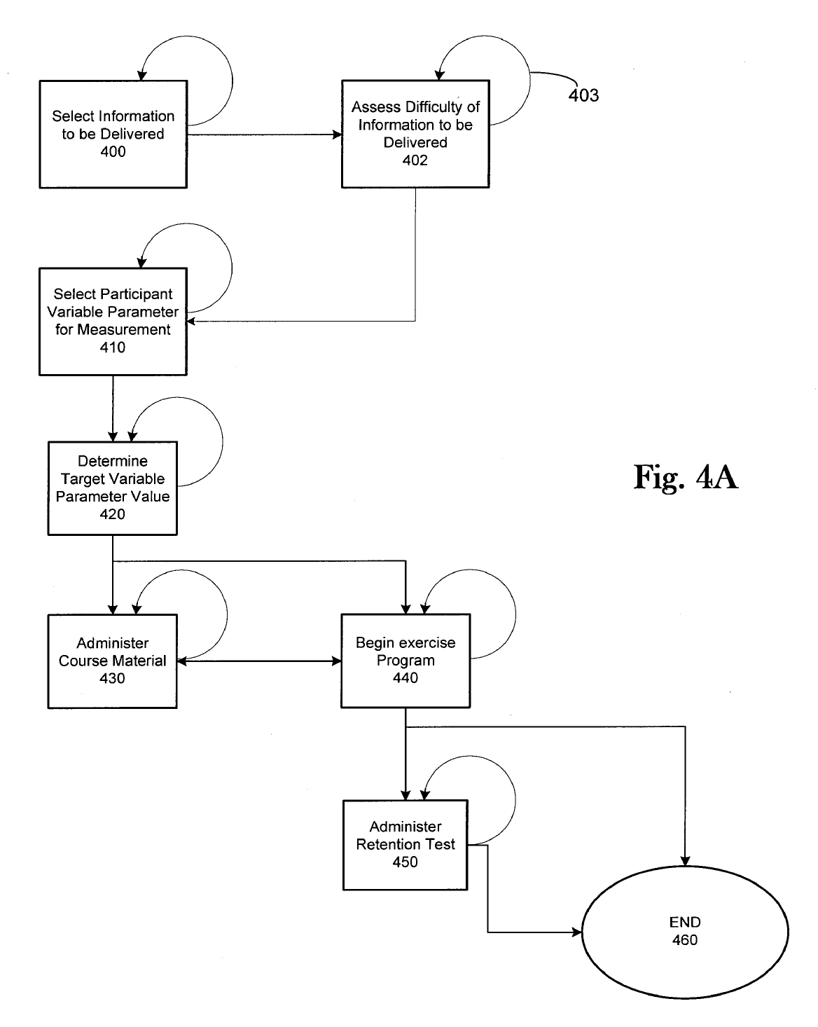

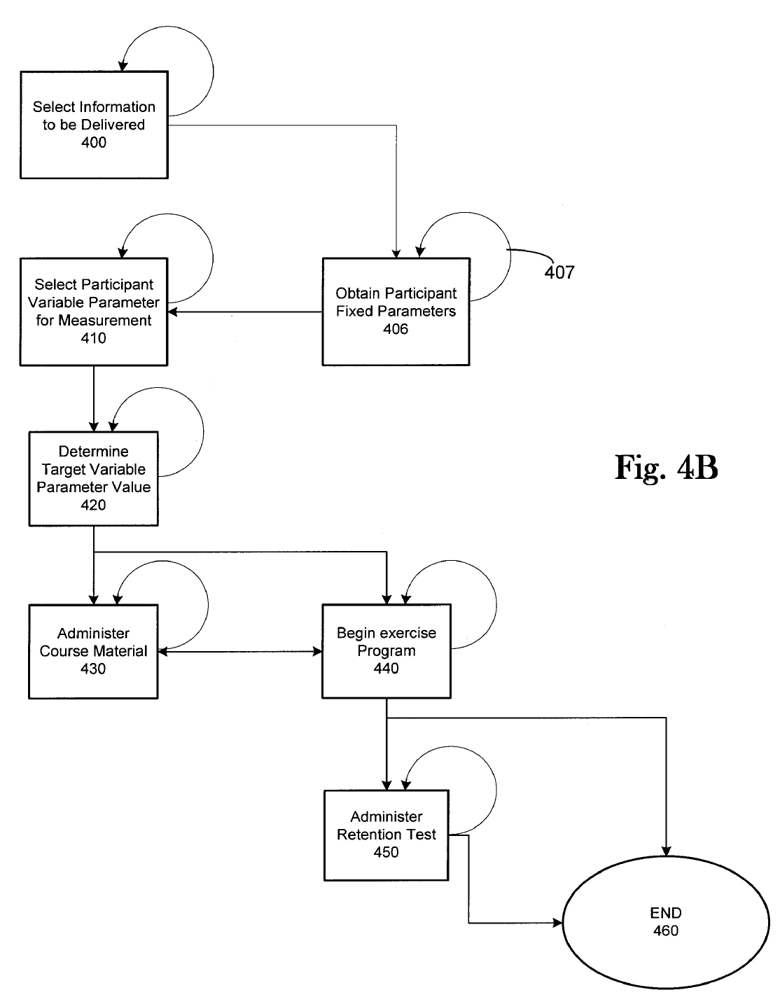

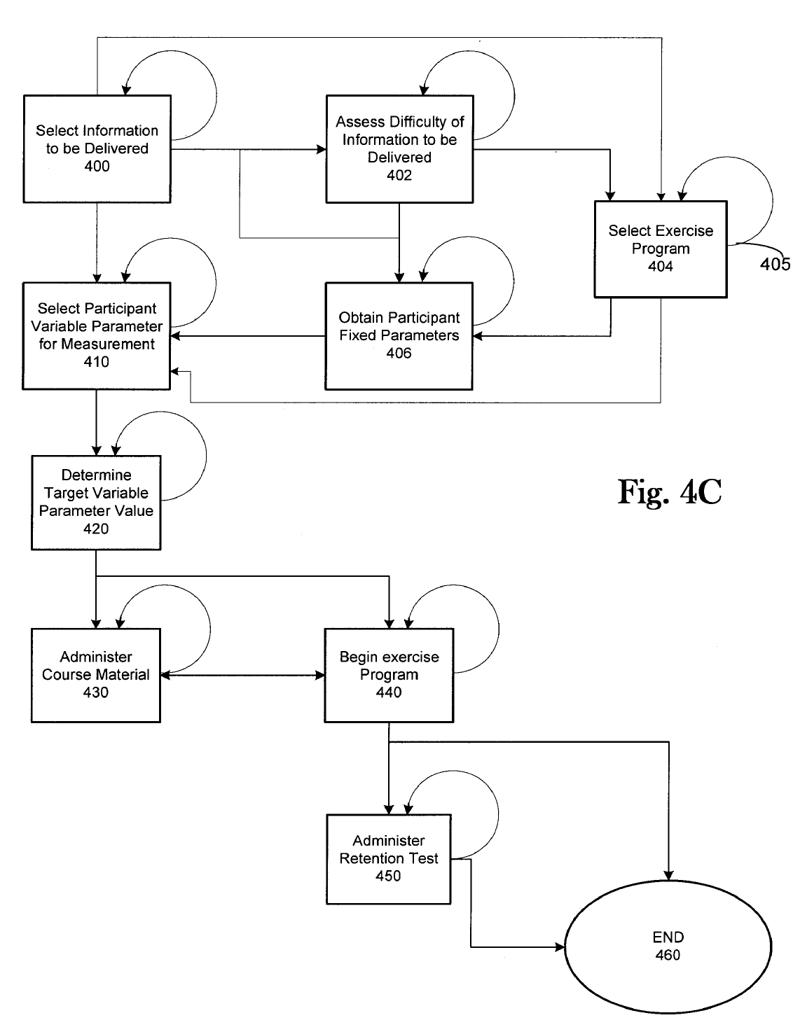

In the embodiment illustrated in FIG. 4A, prior to selecting the participant variable parameter 410, information to be delivered can optionally be assessed to determine the difficulty of the information 402 after it has been selected. The difficulty assessment can be determined by, for example, a profile being associated with a set of material. Alternatively, the information can be analyzed using an algorithm that, for example, performs a fog count to assess readability, analyzes the information on a Flesch Reading Ease scale, or determines the Flesch-Kincaid Grade Level. This step can also be performed one or more times 403, as desired, for example by using multiple techniques, or by providing multiple assessments for blocks of information contained in the material to be delivered. Other mechanisms for determining would be appreciated by those of skill in the art. For example, where available, data concerning difficulty of material could be determined by use of actual retention of material in a group of people. Additionally, information about retention could be extrapolated from small group results to take into consideration other factors, such as education level, etc.

In the embodiment illustrated in FIG. 4B, the participant can provide fixed parameters 406, one or more times 407. Selection of the fixed parameters can include, for example, obtaining information about age, sex, percent body fat, BMI, ethnicity, medications, native language, language aptitude, altitude, cardiovascular endurance ability, fitness assessment, etc. Other parameters could be collected without departing from the scope of the invention. These parameters can be collected at any time, including at the time of registration, as discussed above, or just prior to engaging in the program.

An additional embodiment includes a selection of an exercise program, or type of exercise to accompany the information to be delivered as illustrated in FIG. 4c. As indicated by the flow of the information, an exercise program can be selected 404 either directly after the information to be delivered is selected 400, or after the difficulty of the information is assessed 402, or after participant's fixed parameter has been provided 403. Selection of the exercise program can be made manually by the participant (e.g., participant decides to use the treadmill), or can be made by the system in response to information about the information to be delivered. As with other steps of the method, the step of selecting an exercise program 404, can be repeated 405, without departing from the scope of the invention.

Additionally, it will be appreciated that the exercise can be administered in the form of interval training.

### EXAMPLE 1A

Assess information to be delivered for difficulty 402, for example, as described above, obtain participant fixed parameters 406 are obtained and select an exercise program 404. Correlate the assessment of difficulty and participant parameters to determine suitable exercise programs for selection. Thus, for example, where the material to be delivered has a difficulty of second year college French, and the participant is a native English speaker, in good physical shape, having a BMI of 18, and an age of 16, information may best be delivered while the person is cycling.

### EXAMPLE 1B

Assess information to be delivered for difficulty 402, as described above, obtain participant fixed parameters 406 are obtained and select an exercise program 404. Thus, for example, during delivery of the information a screen within a screen (or picture within a picture) can be viewed that prompts the participant to, for example, increase intensity of exertion during times of delivering material that has a lower level of complexity, and then to reduce the intensity of exertion during times when the complexity of the material delivered increases. In an alternative, the delivery of information can be coded, e.g. color-coded, to provide a prompt to the fitness instructor to change the intensity of the work-out. Such coding can present the prompt at locations throughout the material to be delivered, or can be provided in response to a participant parameter.

As will be appreciated by those skilled in the art, the ordering of these steps, or any steps described herein, can occur as illustrated in the various figures, or can occur in any other order that achieves the objectives of the invention without departing from the scope of the invention.

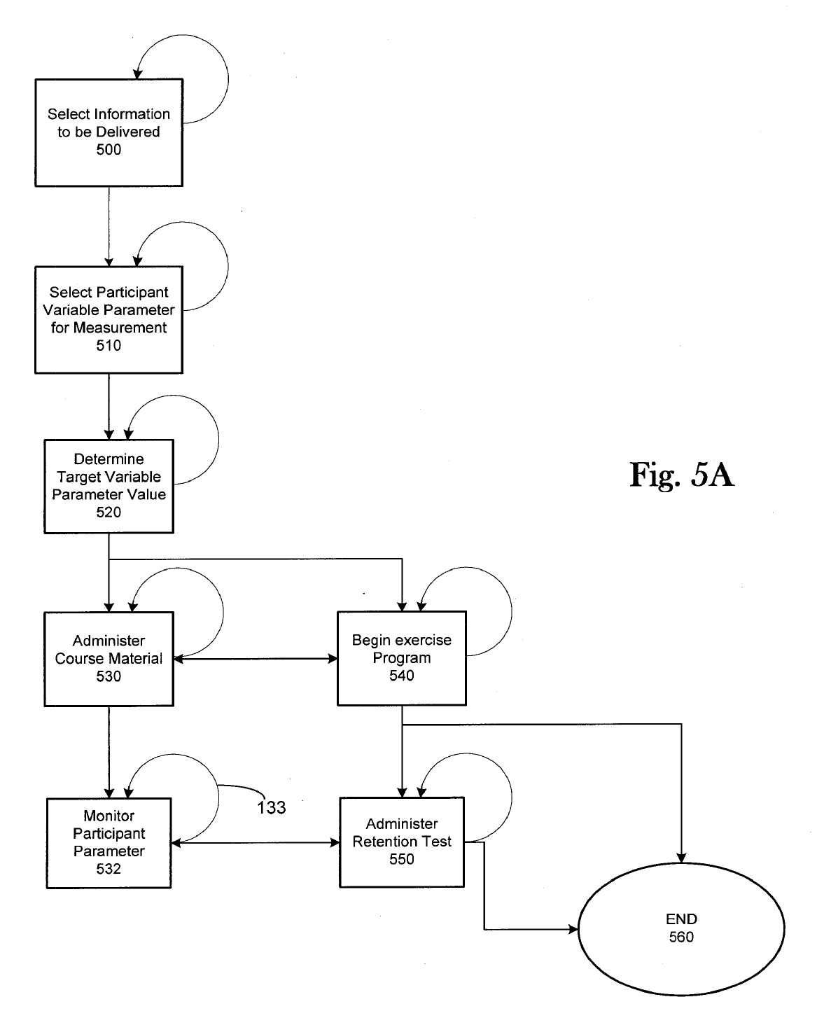

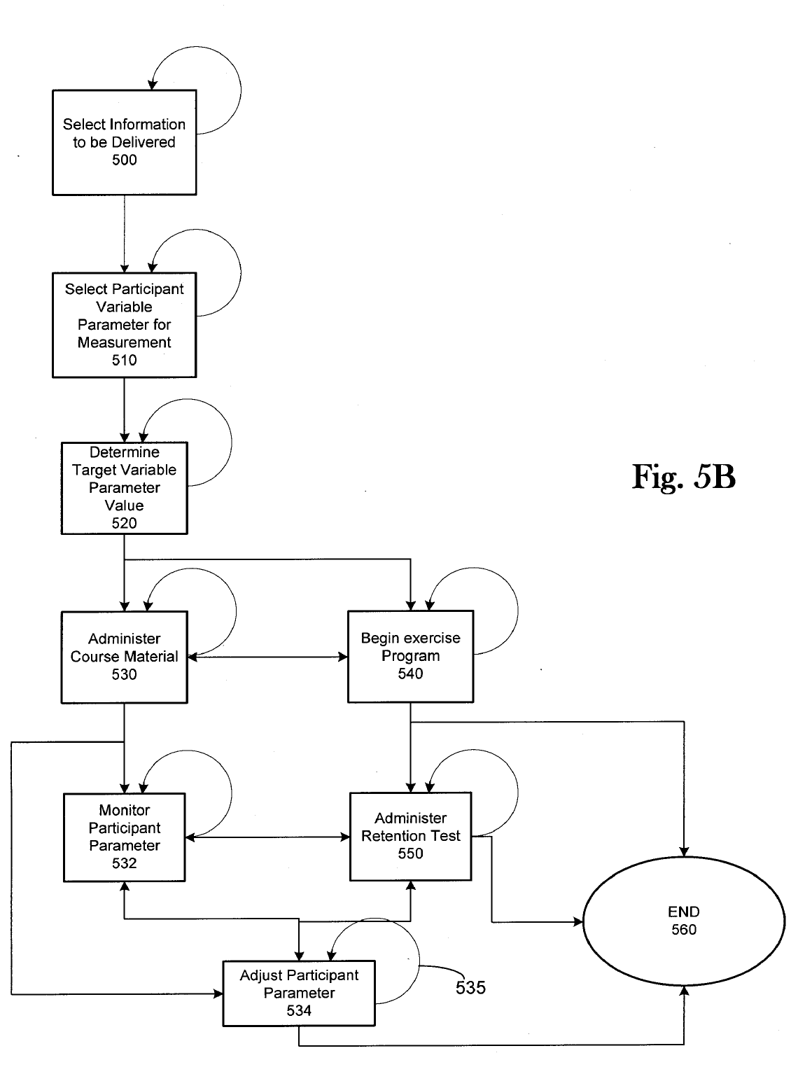

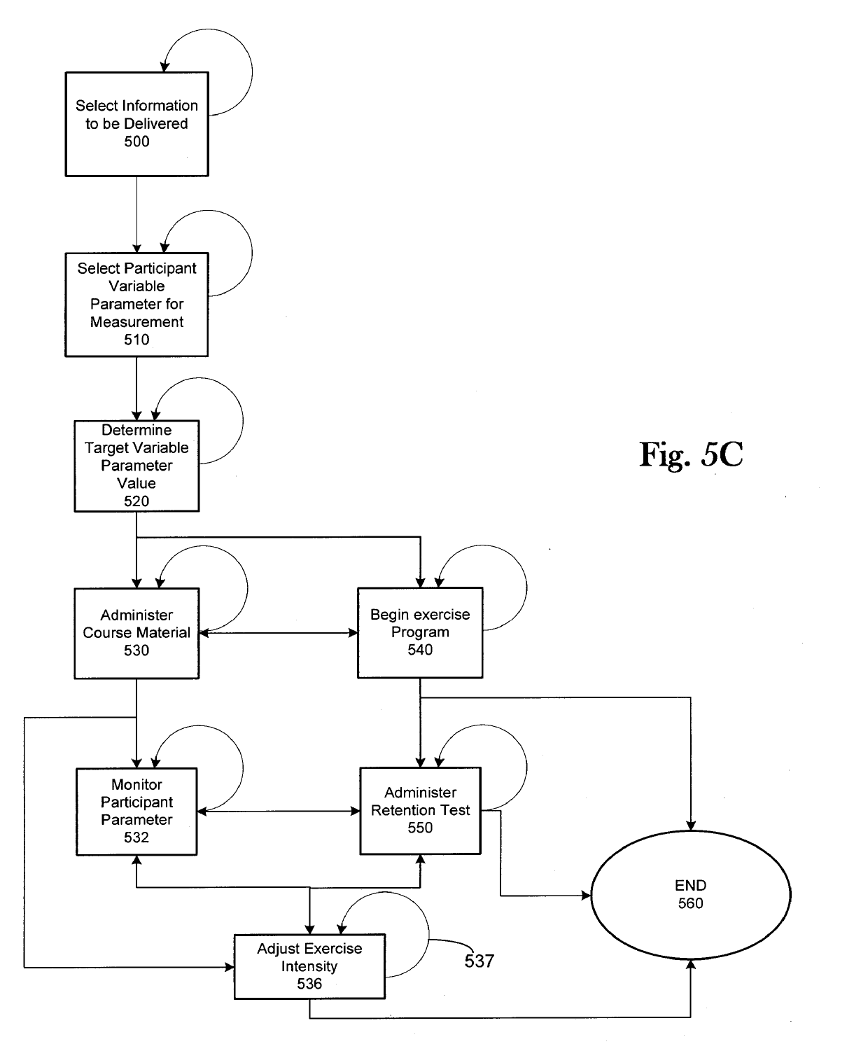

Turning to the embodiment illustrated in FIG. 5A, during or after the administration of the course material 530, the variable patient parameter is monitored 532 to determine whether it is within the target value set at step 520. Monitoring can occur one or more times 533 during or after administration of the course material 530, during or after engaging in the exercise program 540 and/or during or after administering the retention test 550. As discussed above, one or more tests can be administered 550 to determine the retention of the course materials being presented. By incorporating monitoring a participant parameter 532 in the embodiment along with administration of course material, exercise program and retention testing, a feedback loop can be established to ensure that the participant's target variable parameter is within a desired range, wherein the range is the one calculated at step 520, or based on a recalculation performed as a result of, for example, retention testing 550 during the administration of the course materials 530.

### EXAMPLE 2

During the administration of the course material 530 and while engaging in exercise 540, the participant is administered a retention test 550 to determine how much of the information presented has been retained. The variable participant parameter is monitored 532 to determine its value. The results of the retention test 550 and the variable participant parameter 532 are collected for analysis in determining optimal variable parameter. Thus, for example, where the material to be delivered has a difficulty of second year college French, and the participant is a native English speaker, in good physical shape, having a BMI of 18, and an age of 16, the participant has been provided a target variable parameter of x′. During retention testing it is determined that the participant has a retention of 65%. This information could be used for subsequent programs to alter the participant's target variable parameter, or any participant's variable parameter.

In yet another embodiment illustrated in FIG. 5B, the participant parameter determined at 510 is adjusted 520 in response to either monitoring the participant parameter 532 or administering the retention test 550, or a combination of the two.

### EXAMPLE 3

During the administration of the course material 530 and while engaging in exercise 540, the participant is administered a retention test 550 to determine how much of the information presented has been retained. The variable participant parameter is monitored 532 to determine its value. The results of the retention test 550 and the variable participant parameter 532 are correlated to determine whether the target range for the variable participant value should be changed. Thus, for example, where the material to be delivered has a difficulty of second year college French, and the participant is a native English speaker, in good physical shape, having a BMI of 18, and an age of 16, the participant has been provided a target variable parameter of a. During retention testing it is determined that the participant has a retention of 65%. The system re-assesses the target variable parameter based on these results and provides a new target variable parameter of b. This feedback can be presented real-time or near real-time to the participant in order to alter the level of exertion attempted by the participant. In an alternative, the delivery of information can be coded, e.g. color-coded, to provide a prompt to the fitness instructor to change the intensity of the work-out. Such coding can present the prompt at locations throughout the material to be delivered, or can be provided in response to a retention test response.

### EXAMPLE 4

In yet another example, if, during the administration of the course material 530 the parameter measured is heart rate and it is desirable to maintain a heart rate of 68% of maximum for optimal retention of information having a high level of complexity, the participant could receive real-time or near real-time feedback to maintain a heart rate of 68%. However, upon completing a retention test 550, if it is found that the participant had 100% of retention at the target heart rate of 68% it might be desirable to increase the heart rate incrementally for that participant to achieve increased benefit from the exercise component of the program while continuing to maintain an acceptable level of material retention. For example, increase the target heart rate to 70%.

### EXAMPLE 5

In another example, if the parameter measured is heart rate, and the target heart rate is 75% for a participant and a retention test administered 550 during the delivery of course material and while the participant engages in the selected activity results in a score of 60% retention, then the heart rate could be decreased incrementally until a heart rate was employed that enabled the user to achieve a desired level of retention.

### EXAMPLE 6

In another example, delivery of information pertaining to the target course material is achieved by an instructor or system in combination with a personal trainer who delivers information pertaining to form and intensity of work-out. The multiple instructor platform enables the course materials to be delivered by a person knowledgeable in the subject area, while providing an instructor to ensure that participants are properly engaging in the work-out by, for example, providing biomechanical or fitness feedback. The delivery of information can also be coded, e.g. color-coded, to provide a prompt to the fitness instructor to change the intensity of the work-out during delivery of the target course material. Such coding can present the prompt at pre-determined locations throughout the course material to be delivered, or can be provided real time, or near real time, in response to another parameter.

As will be appreciated by those skilled in the art, information, typically educational material, being delivered during exercise by the above referenced system and method can be self selected by the exerciser prior to, or during exercise. In addition to their varying interests in educational subject matter, participants will also vary in their self improvement goals and capabilities. The system and method for delivering a customized educational fitness program is designed to address the problem presented by these varying participant characteristics. Key variable participant parameters can include: level of interest in the educational content; level of interest in the physical exercise component; level of physical fitness; and time availability, to name a few. The exertion level necessary to optimize the retention of information in an educational fitness participant is at or below the anaerobic threshold. Due to this restriction on exertion level during an educational component of the program, non-educational “travel” components are included to facilitate high exertion intervals as well as to support the illusion that the participant is engaged in an educational tour of a location related to the subject matter, thereby increasing participant enjoyment.

In another embodiment of the invention, the system and method can be adapted to work in conjunction with the invention disclosed in U.S. Pat. No. 6,142,913 for “Dynamic Real Time Exercise Video Apparatus and Method” (Ewert). Thus the system can be adapted to incorporate varying video playback rate adjusts the frame rate of motion video content being replayed on a display device based on the intensity at which a participant exerts themselves. This system supports the illusion that the participant is actually traveling through the terrain being displayed. A result of the use of this system is that a participant who exercises at a higher intensity will view more footage than will a participant who exercises at a lower intensity, as the frame rate speed will be higher and more frames of the footage will be viewed.

An additional benefit of the systems and methods disclosed herein is the modularity of the systems and methods. Educational components are provided. The educational components can be Flash based, and virtual motion “travel” components which can be MPEG encoded video files. The components can further be embedded in an HTML base, and driven by custom VC++ based software. The educational fitness modules can also consist of a motion video file with a specific number of frames, and a Flash based educational file of a set time length. The system and method for delivering a customized modular educational fitness program is designed to customize the embedded content such that the educational fitness program has the characteristics desired by a specific participant. This can be accomplished by pairing Flash based educational files of a standard length with motion video files with varying numbers of frames.

### EXAMPLE 7

A participant begins an educational fitness program. They have selected a program which focuses heavily on the physical exertion aspect, and less on the educational aspect. They have selected the subject matter of Beginner Spanish in Puerto Vallarta, and an educational workout time of 30 minutes. Based on these parameters, the system loads a presentation that includes 2 Flash based educational modules of a standard 8 minute length, and 2 associated motion video files, with a number of frames that will take approximately 7 minutes each to view when played back to a participant exercising at a high exertion intensity level.

### EXAMPLE 8

A participant selects a program which focuses more heavily on the educational aspect. They have selected the subject matter of Beginner Spanish in Puerto Vallarta, and an educational workout time of 30 minutes. Based on these parameters, the system loads a presentation that includes 3 Flash based educational modules of a standard 8 minute length, and 3 associated motion video files, with a number of frames that will take approximately 2 minutes each to view when played back to a participant exercising at a moderate exertion intensity level.

Alternatively, the VC++ based software can be altered to switch between virtual motion “travel” components, and educational components based on set time parameters that are input by the participant through the interface device. In this embodiment of the invention, the software receives a variable or set of variables which is input by the participant, selects the number of educational modules that will be presented, and selects motion video files with a sufficient number of frames. The system then “cuts off” the motion video components of the program at the appropriate time intervals, by initiating the educational components regardless of the distance “traveled” by the participant.

Alternatively, participant variables and parameters can be stored in a database accessible to the content delivery device. The system can then determine the proper content delivery parameters with no direct input from the participant at the time of use.

In another aspect of the invention, feedback regarding exertion performance is collected by the CPU and stored in the system's database. Additionally, feedback from the educational assessments administered to the participant during the program is also stored in the system's database. This provides the system the ability to produce detailed assessments of the participant's performance, both physical and mental, during the program. This information can then be presented to the participant, such as through a web based portal, for several purposes including: Comparing physical and educational performance to previously stored goals created for or by the participant, making suggestions for changing exertion patterns to facilitate better educational performance, making suggestions for changing total program patterns to facilitate better educational, physical, or total performance, offering of incentives or facilitating participation in competitions with other participants.

In another aspect of the invention, all feedback as discussed above, as well as all customizability as discussed above, can rest in the control of a manager, executive, trainer, or other such supervisory individual, who has some or total control, such as through a web based portal, over customizability of the program, the available list of subject matter, as well as some or total ability to review performance and/or make program adjustments based on system recommendations.

In any of the embodiments described above, the fitness instructor and/or the educational instructor can be provided with the materials concerning the information to be delivered and desired intensity prior to the scheduled delivery of information. Other information can also be provided, such as, participant parameters to be monitored, etc. The information can be marked to provide the instructor(s) with prompts, e.g. by color coding, or providing actual instructions. Thus, for example, where slides or PowerPoint are used, the slides of the presentation can be color coded or include a numbered indicator at the bottom that provides a signal to the instructor(s) to adjust intensity during the workout. Change of intensity can be physical intensity or mental intensity (e.g., providing an indicator to the instructor to increase the rate at which participants are pedaling a Spinning® cycle, or providing an indicator to the instruction to increase the rate at which, for example, vocabulary drills are conducted in Spanish).

As will be appreciated by those skilled in the art, in some embodiments a participant could indicate a desired retention level that was less than 100% in order to engage in a more strenuous work-out while still achieving a desired retention of material. Thus for example, the participant could be asked to indicate the level of retention the participant would like to achieve for the material. For course work directed to an interesting, non-essential subject, for example, wine tasting for someone not engaged in a profession that requires a high degree of knowledge about wine, the participant could indicate, for example, that an 80% retention of material was adequate. From that input the system could then determine that while a 100% retention of material would require a target parameter of x, the lower retention acceptable to the participant would require a target parameter of y, thus enabling the participant to work out at a stronger intensity while still achieving a satisfactory retention of material presented.

In yet another embodiment illustrated in FIG. 5C, the participant is provided feed back to adjust exercise intensity 536 or the equipment which the participant has chosen to exercise on is instructed to alter its output to effectively adjust the exercise intensity for the participant. The feedback loop for the exercise intensity can be adjusted multiple times 537 without departing from the scope of the invention.

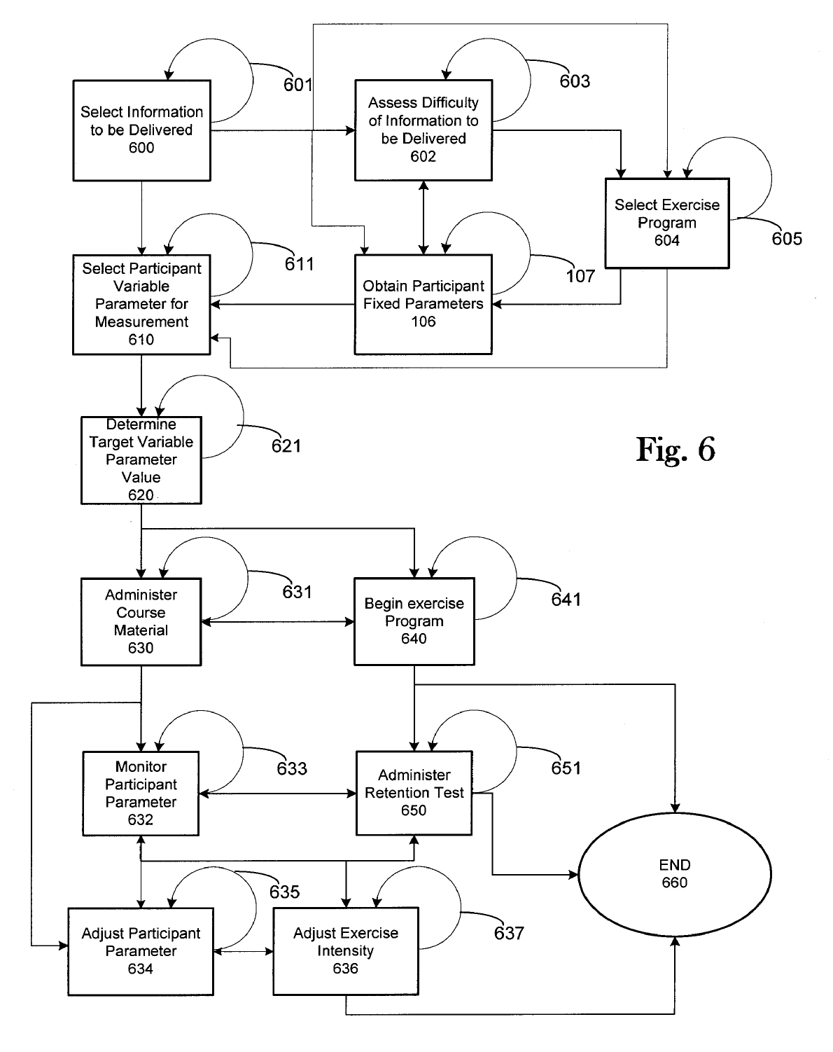

FIG. 6 illustrates a flow chart illustrating the method steps illustrated in FIGS. 3-5 and described above. As evidenced by the flow of information, one or more of the steps depicted can be omitted without departing from the scope of the invention.

Assessment of retention of information can be achieved in a variety of manners that would be apparent to those skilled in the art and includes, but is not limited to the use of a PRS device that communicates with a computer. Commercially available devices are, for example, those sold under the trade name Interwrite PRS by GTCO Calcomp (Columbia Md.). See, U.S. Pat. No. 6,930,673 entitled Collaborative Input System (Kaye et al.). In that instance, the participant would be asked a question that reflects the material presented and be required to select an answer (e.g., yes or no, true or false, a/b/c/d). Based on the response to one or more questions presented, an assessment of retention could be determined for the participant and feedback could then be provided. The PRS devices can also be configured to enable the participant to manually enter information pertaining to one or more of the participant's parameters, as desired.

Participants in this system include adults and minors (i.e. persons under the age of 18). This system would have useful applications for providing informational material optimized with engaging in exercise, as described, as well as improving information retention for persons having, for example, attention deficit disorder, or other learning disabilities. Improvements and alterations to the system will be apparent to those skilled in the art upon reviewing this disclosure.

### EXAMPLE 9

In another example, delivery of information pertaining to the target course material is achieved by an instructor or system in combination to a form and intensity of work-out. Information and work-out intensity is modularized for a particular exercise session such that each modular can be allocated into one of three potential categories. An interaction zone (IZ) corresponds to a rating of perceived exertion where the participant feels that the exertion level is light. During this zone, material presented would require interaction or socialization, e.g., practice conversing in Spanish. A learn zone (LZ) corresponds to a rating of perceived exertion where participants have a rating of perceived exertion whereby the participant feels that they are working out somewhat hard. During this zone, information that is intended to be retained would be delivered; minimal socialization or interaction would occur. Lastly a burn zone (BZ) corresponds to a rating of perceived exertion whereby the participant feels that they are working out very hard. At this juncture information delivery would be directed to simpler items, such as vocabulary drills.

As will be appreciated by those skilled in the art, the rating of perceived exertion (which is a self-assessment provided by the user) could be correlated with an actual physiological values, e.g. for a heart rate monitor, which could then be used to determine intensity of work-out without departing from the scope of the invention. Alternative, the rating of perceived exertion could be exchanged with the use of biological feedback systems (such as a heart rate monitor) or could be altered based on a calibration test (discussed below) taken by a participant prior to participating in the class.

Modularization of the classes and information presentation can enable the information delivery to be optimized to desired work-out levels. Thus, a class could be comprised of only Interaction and Learning Zone blocks, a combination of Interaction, Learning and Burn Zone block, as well as any other combination. Additionally, the blocks can be for set amounts of time such that multiple blocks can be provided in a plurality of orders. For example, where each block is 6 minutes, a 60 minute class could be organized as follows: IZ; LZ, BZ, BZ, LZ, BZ, LZ, LZ, LZ, IZ.

Additionally, prior to participating in a program, a participant could run a calibration program, for example, on a programmable cycle. In such an instance, the cycle would then instruct the participant on a random topic or run a test, such as a memory or logic test, while the participant worked-out. The cycle would alter the intensity of the work-out through different segments of the calibration workout and assess the participant's retention and/or success on an individual segment. Based on the feedback, the cycle could then provide the user with a personalized exertion pattern than would optimize learning and enjoyment.

### EXAMPLE 10

In yet another example, the system is used in a corporate or military training environment where self-service fitness machines, such as bicycles, are provided. Such bicycles, or machines, could be provided with a screen incorporated therein in order to facilitate immediate user feedback, or portable devices such as video ipods could be used. An on-screen question/answer session would be presented to the user while using the fitness machine via the screen. Responding real-time could be monitored either simultaneously or subsequently to ensure actual participation and/or learning was occurring. The real-time interaction could also be incorporated with biometrics to ensure the identity of the person engaging in the training and response, for further assurance of continuing education units. Responses from a participant, or identified participant where participant identification is provided for, is entered into a database either in the training device or remotely where the device communicates with, for example, a server. The training device could also cap exercise intensity or automatically deuce intensity during feedback sessions to facilitate the ability of a user to adequately respond.

While preferred embodiments of the present invention are shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the claims following the description define the scope of the invention and that methods and structures within the scope of these claims and equivalents are covered thereby.

What is claimed is:

1. A system for delivering information to a participant at an information delivery site comprising:
(a) a participant parameter measuring device capable of measuring a participant specific parameter; and
(b) an information delivery system capable of delivering information to a participant while the participant is engaged in an activity.

2. The system of claim 1 further comprising a participant parameter receiving device adapted and configured to receive the participant parameter measured by the participant parameter measuring device.

3. The system of claim 1 further comprising a central system capable of communicating with an information delivery site having the participant parameter measuring device and the material delivery system.

4. The system of claim 1 further comprising a participant interactive data entry device.

5. A method of delivering information comprising:
(a) selecting information to be delivered;
(b) selecting a participant variable parameter for measurement;
(c) determining a target variable for the participant variable parameter; and
(d) delivering information,
wherein during the step of delivering information, the participant is engaged in an exercise program.

6. The method of claim 5 wherein the step of selecting information to be delivered is performed a plurality of times.

7. The method of claim 5 wherein the step of delivering information is performed by an instructor.

8. The method of claim 5 wherein the step of delivering information is performed by a first instructor and a second instructor.

9. The method of claim 5 wherein the step of selecting a participant variable parameter for measurement is performed a plurality of times.

10. The method of claim 5 wherein the step of determining a target variable for the participant variable parameter is performed a plurality of times.

11. The method of claim 5 wherein the step of administering course materials is performed a plurality of times.

12. The method of claim 5 wherein the steps of administering course materials and engaging in an exercise program occur simultaneously.

13. The method of claim 5 further comprising the step of administering a retention test.

14. The method of claim 5 further comprising the step of assessing the difficulty of the information to be delivered.

15. The method of claim 5 further comprising the step of obtaining participant fixed parameters.

16. The method of claim 15 wherein the step of obtaining participant fixed parameters is performed a plurality of times.

17. The method of claim 5 further comprising the step of selecting an exercise program.

18. The method of claim 5 further comprising two or more of the steps of: assessing the difficulty of information to be delivered, obtaining participant fixed parameters and selecting an exercise program.

19. The method of claim 5 further comprising the step of monitoring a participant parameter.

20. The method of claim 19 wherein the step of monitoring a participant parameter is performed a plurality of times.

21. The method of claim 19 wherein the step of monitoring a participant parameter is performed real-time.

22. The method of claim 5 further comprising the step of adjusting a participant parameter.

23. The method of claim 19 further comprising the step of adjusting a participant parameter in response to the monitored participant parameter.

24. The method of claim 5 further comprising the step of adjusting exercise intensity.

25. The method of claim 24 wherein the step of adjusting exercise intensity includes adapting output parameters of an exercise device being used by a participant.

26. A method of delivering information comprising:
(a) selecting information to be delivered;
(b) selecting an exertion level for a participant; and
(c) delivering information,
wherein during the step of delivering information, the participant is engaged in an exercise program.

27. A method of optimizing information retention comprising:
(a) selecting information to be delivered;
(b) selecting an exertion level for a participant; and
(c) delivering information,
wherein during the step of delivering information, the participant is engaged in an exercise program at the selected exertion level.
